(19) United States
(12) Patent Application Publication
(10) Pub. No.: US 2026/0160699 A1
(43) Pub. Date: Jun. 11, 2026

(54) INSPECTION EQUIPMENT AND INSPECTION METHOD

(71) Applicant: Samsung Display Co., LTD., Yongin-si (KR)

(72) Inventors: NURI JUNG, Yongin-si (KR); MINCHAN PARK, Yongin-si (KR); MOONHYUK KIM, Yongin-si (KR); HYEJIN LEE, Yongin-si (KR); DAEKI PARK, Yongin-si (KR); SEUNGWOOK LEE, Yongin-si (KR); HO-YOUN CHO, Yongin-si (KR)

(21) Appl. No.: 19/182,083

(22) Filed: Apr. 17, 2025

(30) Foreign Application Priority Data
Aug. 9, 2024 (KR) 10-2024-0106545

(51) Int. Cl. G01N 21/88; G01N 21/958

(52) U.S. Cl. CPC G01N 21/8806; G01N 21/958; G01N 2021/8809; G01N 2021/8812; G01N 2021/8835

(57) ABSTRACT

An inspection apparatus includes a lighting unit which radiates light onto a surface of a target panel by adjusting an angle, an imaging unit which captures an image of an area of the target panel irradiated with the light by the lighting unit, a first transferring unit which moves the lighting unit at above the target panel, and a second transferring unit which moves the imaging unit above the target panel.

This application claims priority to Korean Patent Application No. 10-2024-0106545, filed on Aug. 9, 2024, and all the benefits accruing therefrom under 35 U.S.C. § 119, the content of which in its entirety is herein incorporated by reference.

### BACKGROUND

### 1. Field

The disclosure relates to an inspection equipment and an inspection method, and more specifically, to an inspection equipment and an inspection method with enhanced reliability in defect determination.

### 2. Description of the Related Art

Multimedia electronic devices, such as televisions, mobile phones, tablets, computers, navigation systems, and gaming consoles, may be equipped with display panels for displaying images. Display panels may include internal intrinsic defects, surface intrinsic defects, and surface extrinsic defects.

### SUMMARY

Embodiments of the disclosure provide an inspection equipment and an inspection method with an enhanced reliability in defect determination.

According to an embodiment of the disclosure, an inspection equipment includes: a lighting unit which radiates light onto a surface of a target panel by adjusting an angle; an imaging unit which captures an image of an area of the target panel irradiated with the light by the lighting unit; a first transferring unit which moves the lighting unit at above the target panel; and a second transferring unit which moves the imaging unit above the target panel.

In an embodiment, the lighting unit may include a light source which emits unidirectional diffused light.

In an embodiment, the target panel may be transferred in a first direction, and the first transferring unit may include a first support movable in the first direction, where the lighting unit may be disposed on the first support.

In an embodiment, the second transferring unit may include a second support movable move in both the first direction and a second direction intersecting the first direction, where the imaging unit may be disposed on the second support.

In an embodiment, the first support may be provided in plurality. In such an embodiment, the lighting unit may be disposed on each of a plurality of first supports, and the plurality of first supports may be arranged in parallel with each other in the first direction, with adjustable spacing between the plurality of first supports.

In an embodiment, the second support may be provided in plurality. In such an embodiment, the imaging unit is disposed on each of a plurality of second supports, and the plurality of second supports may be arranged in parallel with each other in the first direction, with adjustable spacing between the plurality of second supports.

In an embodiment, the plurality of second supports may be movable in the second direction while maintaining the spacing between the plurality of second supports in the first direction.

In an embodiment, the imaging unit may include a plurality of cameras disposed along the second support extending in the second direction.

In an embodiment, the lighting unit may adjust an angle of a light source inside the lighting unit.

In an embodiment, an angle of a supporting member, which supports the lighting unit, may be adjustable.

In an embodiment, the lighting unit may include a plurality of unit lights linearly arranged on the first support extending in the second direction.

According to another embodiment of the disclosure, an inspection method includes: disposing a target panel at an inspection point; radiating light onto a surface of the target panel by adjusting an angle of light irradiation; and capturing an image of an area of the target panel irradiated with the light. In such an embodiment, in the radiating light, the angle of light irradiation is adjusted in a way such that reflection from surface scratches of the target panel is reduced.

In an embodiment, in the radiating the light, unidirectional diffused light may be radiated to the target panel.

In an embodiment, in the disposing the target panel, the target panel may be transferred in a first direction, and the radiating the light may include radiating the light onto a plurality of inspection areas of the target panel using a plurality of lights arranged in parallel with each other in the first direction.

In an embodiment, the capturing the image may include obtaining images, respectively, from the plurality of inspection areas of the target panel by use of a plurality of cameras.

In an embodiment, the capturing the image may include moving the plurality of cameras in a second direction intersecting the first direction while maintaining spacing between the plurality of cameras in the first direction.

In an embodiment, in the radiating the light, the angle of light irradiation is adjusted to allow an image of surface scratches to be indistinguishable from a surface image of the target panel in a captured image of the target panel.

In an embodiment, in the captured image of the target panel, an image of surface foreign substance on the target panel may be distinguishable from the surface image of the target panel.

In an embodiment, in the radiating the light, the angle of light irradiation may be adjusted by adjusting an angle of a light source inside a lighting unit.

In an embodiment, in the radiating the light, the angle of light irradiation may be adjusted by adjusting an angle of a support member which supports the lighting unit.

According to embodiments of the disclosure, the reliability of defect determination may be enhanced by selectively inspecting a specific type of defects occurring in the panel among various types of defects.

### BRIEF DESCRIPTION OF THE DRAWINGS

These and/or other features of embodiments of the disclosure will become apparent and more readily appreciated by describing in further detail embodiments thereof with reference to the accompanying drawings, in which:

FIG. 1 illustrates various types of defect in a panel;

FIG. 2 is a perspective view of an inspection equipment according to an embodiment of the disclosure;

FIG. 3 is a side view of the inspection equipment according to an embodiment of the disclosure;

FIGS. 4 and 5 illustrate an embodiment of a method for selectively inspecting defects occurring in the panel;

FIGS. 6 and 7 illustrate how spacing is adjusted in the inspection equipment according to an embodiment of the disclosure;

FIG. 8 illustrates a lighting unit in the inspection equipment according to another embodiment of the disclosure; and

FIG. 9 is a flowchart illustrating an inspection method according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the disclosure shall not be restricted to the thicknesses, ratios, dimensions, etc. illustrated in the drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

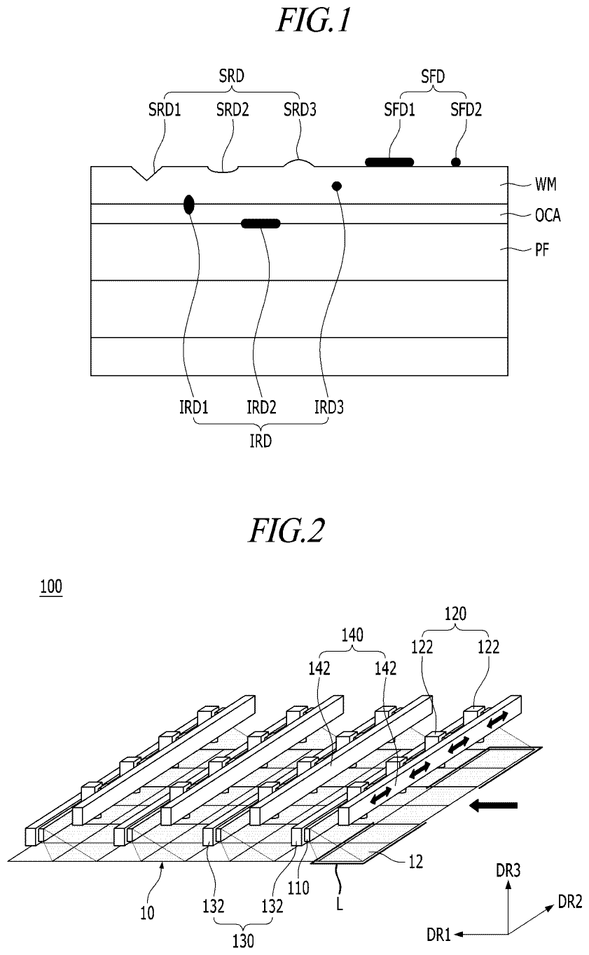

FIG. 1 is a diagram illustrating various types of defects in a panel. The panel may include internal intrinsic defects IRD, surface intrinsic defects SRD, or surface extrinsic defects SFD.

The internal intrinsic defects IRD in a panel may be defects present inside the panel, rather than on a surface of the panel. A plurality of internal intrinsic defects IRD may be intrinsic defects located in internal layers stacked in a thickness direction of the panel. The internal intrinsic defects IRD may be defects occurring during the lamination process or defects associated with the laminated structures. For example, defects may occur during the lamination process, including scratches, indentations, abrasion, foreign substances, or bubbles on a polarizer.

The internal intrinsic defects IRD may include a first internal intrinsic defect IRD1, a second internal intrinsic defect IRD2, and a third internal intrinsic defect IRD3. The first internal intrinsic defect IRD1 may be a defect occurring at a position or located between an adhesive layer OCA and a window WM. The first internal intrinsic defect IRD1 may be a foreign substance adhered to the adhesive layer OCA or a foreign substance not removed during a bonding process with the window WM. The second internal intrinsic defect IRD2 may be a defect occurring at apposition or located between the adhesive layer OCA and an optical film PF. The second internal intrinsic defect IRD2 may be a foreign substance adhered to the optical film PF or a foreign substance not removed while coating the adhesive layer OCA. The third internal intrinsic defect IRD3 may be a defect occurring at a position or located inside the window WM.

The surface intrinsic defects SRD may be defects present on the surface of the panel. A plurality of surface intrinsic defects SRD may be scratches, indentations, or protrusions on the surface of the window WM.

The surface intrinsic defects SRD may include a first surface intrinsic defect SRD1, a second surface intrinsic defect SRD2, and a third surface intrinsic defect SRD3. The first surface intrinsic defect SRD1 may be a portion sharply indented on the window WM. The first surface intrinsic defect SRD1 may appear in the form of a long scratch. The second surface intrinsic defect SRD2 may be an impression indented on the window WM. The third surface intrinsic defect SRD3 may be a portion protruded in the form of a bump on the window WM.

The surface extrinsic defects SFD may be fingerprints, airborne foreign substances, contamination, or adhesives that occur during handling of the equipment or due to the environment in the manufacturing process of the panel. The surface extrinsic defects SFD may include a first surface extrinsic defect SFD1 and a second surface extrinsic defect SFD2. The first surface extrinsic defect SFD1 may be a defect with a small height and wide surface area on the window WM, and the second surface extrinsic defect SFD2 may be a defect with a big height and narrow surface area on the window WM. Although the internal intrinsic defects IRD, the surface intrinsic defects SRD, and the surface extrinsic defects SFD are illustratively depicted in FIG. 1, the shapes and positions of the plurality of defects are not limited thereto.

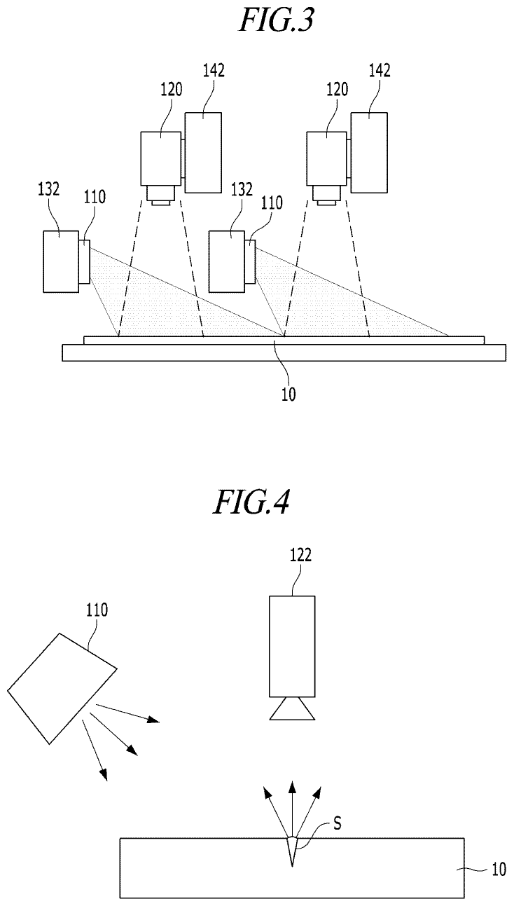

FIG. 2 is a perspective view of an inspection equipment according to an embodiment of the disclosure, and FIG. 3 is a side view of the inspection equipment according to an embodiment of the disclosure. Referring to FIGS. 2 and 3, inspection equipment 100 according to an embodiment of the disclosure may include a lighting unit 110, an imaging unit 120, a first transferring unit 130, and a second transferring unit 140.

The lighting unit 110 is configured to radiate light onto a surface of a target panel 10, which is a subject of inspection. The lighting unit 110 is configured to adjust an angle of light irradiation (i.e., a direction of radiating the light) relative to the surface of the target panel 10.

In an embodiment, the target panel 10 may be a display panel configured to display an image in response to electrical signals. The target panel 10 may have a flat structure, which may have a rectangular shape, with edges extending in a first direction DR1 and a second direction DR2, which intersects the first direction DR1, on a plane or in a plan view. The target panel 10 may be configured to display images in a third direction DR3 through a display surface formed parallel to the plane defined by the first direction DR1 and the second direction DR2. The third direction DR3 may be a thickness direction of the target panel 10 that is substantially parallel to the normal direction of the display surface, which may correspond to a front surface of the target panel 10.

In an embodiment, the target panel 10 may be a mother panel. The mother panel may be divided into a plurality of cell panels 12 to match the size of a device configured to display images.

Referring to FIGS. 2 and 3, the lighting unit 110 in an embodiment is configured to radiate light onto a surface of the mother panel. The mother panel may have a rectangular shape with edges extending in the first direction DR1 and the second direction DR2 and may form a grid structure divided into a plurality of columns in the first direction DR1 and the second direction DR2. Each divided grid may correspond to or form a cell panel 12.

The target panel 10 may be configured to be transferred in the first direction DR1. In an embodiment, the mother panel may be transferred in the first direction DR1, and the lighting unit 110 may be configured to radiate light onto a single line L of cell panels 12 that form a single column in the second direction DR2.

The lighting unit 110 may be configured to radiate light in an illumination area corresponding to a width of the mother panel in the second direction DR2. In an embodiment, for example, a width of the illumination area formed by lighting of the lighting unit 110 may be equal to or greater than the width of the mother panel in the second direction DR2. Accordingly, the lighting unit 110 may be configured to radiate light, one column at a time, onto the single line L of cell panels 12 forming the single column in the second direction DR2.

In an embodiment, the lighting unit 110 may be configured to adjust the angle of light irradiation relative to the target panel 10. In an embodiment, for example, an angle of a light source (or a light emitting surface thereof) inside the lighting unit 110 may be adjusted, or an angle of a supporting member (not shown) supporting the lighting unit 110 may be adjusted.

In an embodiment, the lighting unit 110 may include unidirectional diffused lighting. That is, the lighting unit 110 may be provided with a light source configured to emit light with a diffusing property, rather than parallel light, with directionality toward an inspection area of the target panel 10.

The imaging unit 120 may be configured to capture an image of an area of the target panel 10 irradiated with the light by the lighting unit 110. Referring to FIGS. 2 and 3, the imaging unit 120 of an embodiment may include a camera 122 configured to capture an image of the surface of the target panel 10 from above the cell panel 12 irradiated with the light by the lighting unit 110. The camera 122 may be arranged in plurality in the second direction DR2 to capture images when the lighting unit 110 radiates light onto the single line L of cell panels 12 arranged in the second direction DR2. Moreover, the cameras 122 may also be configured to move (or movable) in the second direction DR2 to capture images of each cell panel 12.

The first transferring unit 130 may be configured to move (or movable) the lighting unit 110 above the target panel 10. Referring to FIGS. 2 and 3, the first transferring unit 130 in an embodiment may include a first support 132 configured to move (or movable) in the first direction DR1. The lighting unit 110 may be disposed or installed on (e.g., fixed or attached to) the first support 132.

In an embodiment, for example, the first support 132 may have a bar structure extending in the second direction DR2. In such an embodiment, the lighting unit 110 may include a light source having the bar structure extending in the second direction DR2 and attached to a side of the first support 132. Accordingly, the lighting unit 110 may be configured to move (or movable) in the first direction DR1, to be selectively positioned to radiate light onto the single line L of cell panels 12 arranged in the second direction DR2.

In the first transferring unit 130, the first support 132 may be provided in plurality, and the lighting unit 110 may be installed on each of a plurality of first support 132. The plurality of first supports 132 may be arranged parallel to each other in the first direction DR1.

In an embodiment, the first transferring unit 130 may include a probe for supplying power or signals for image inspection of the cell panels 12. In an embodiment, the lighting unit 110 and the imaging unit 120 may be configured to perform defect inspection after the first transferring unit 130 is moved around the single line L of cell panels 12. Subsequently, the probe of the first transferring unit 130 may supply power and signals to the single line L of cell panels 12 to perform image inspection. Therefore, it is possible to proceed with a surface defect inspection and an image inspection of the panel successively.

The second transferring unit 140 may be configured to move (or movable) the imaging unit 120 above the target panel 10.

Referring to FIGS. 2 and 3, the second transferring unit 140 in an embodiment may include a second support 142 configured to move (or movable) in the first direction DR1 and the second direction DR2. The imaging unit 120 may be disposed or installed on (e.g., fixed or attached to) the second support 142.

In an embodiment, for example, the second support 142 may have a bar structure extending in the second direction DR2 and a plurality of cameras 122 may be installed on the bar structure, with a space between the plurality of cameras 122 along the second support 142. Accordingly, the imaging unit 120 may be configured to move (or movable) in the first direction DR1, to be aligned with a column of cell panels 12 arranged in the second direction DR2 to obtain images. In an embodiment, the imaging unit 120 may be configured to move (or movable) in the second direction DR2 and capture images from each cell panel 12 from the single line L of cell panels 12.

In the second transferring unit 140, the second support 142 may be provided in plurality, the imaging unit 120 may be attached to each of a plurality of second support 142. The plurality of second supports 142 may be arranged parallel to each other in the first direction DR1. Accordingly, it is possible to obtain images and perform a defect inspection simultaneously for multiple cell panels 12 forming a plurality of columns in the second direction DR2.

FIGS. 4 and 5 are diagrams illustrating an embodiment of a method for selectively inspecting defects occurring in a panel. Referring to FIGS. 4 and 5, when light is radiated onto the surface of the target panel 10, significant scattering occurs in an extrinsic defect caused by a surface foreign substance O, whereas less scattering occurs in an intrinsic defect caused by a surface scratch S. Particularly, by adjusting an irradiation angle of unidirectional diffused light, it is possible to reduce scattering caused by the scratch S. When an irradiation angle of unidirectional diffused light is adjusted, the amount of light reflected from the intrinsic defect caused by the scratch S may be adjusted to be similar to the amount of light reflected from a normal surface of the target panel 10.

Therefore, in an embodiment, by adjusting the angle of light radiated from the lighting unit 110, the intrinsic defect caused by the surface scratch S may not be allowed to appear in the image, but the extrinsic defect caused by the surface foreign substance O may be allowed to selectively appear in the image. That is, according to an embodiment, it is possible to selectively inspect the surface foreign substance O while excluding the surface scratch S from the inspection on the target panel 10.

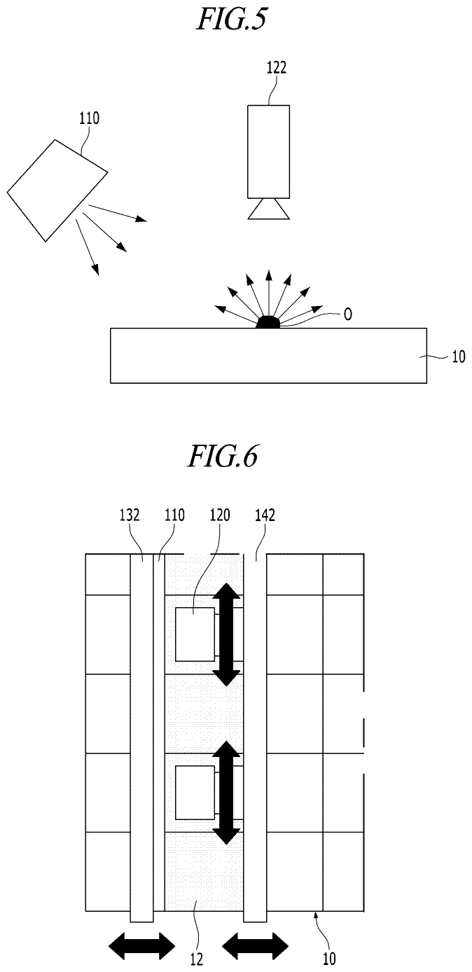

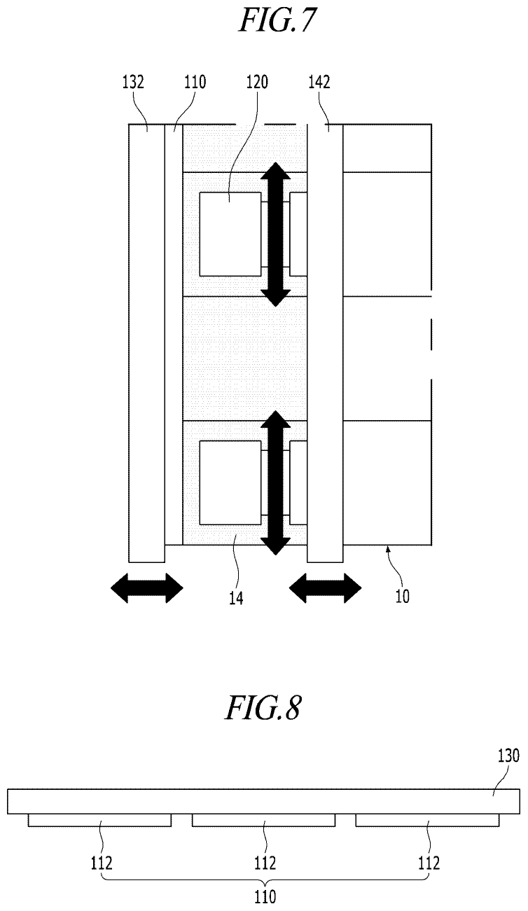

FIGS. 6 and 7 are diagrams illustrating how spacing is adjusted in the inspection equipment 100 according to an embodiment of the disclosure. Referring to FIGS. 2, 3, 6, and 7, in an embodiment, the plurality of first supports 132 may be arranged parallel to each other in the first direction DR1, with adjustable spacing therebetween. In an embodiment, for example, the spacing between the plurality of first supports 132 may be adjusted to match the size of the cell panels 12, 14 on the mother panel. Accordingly, the lighting unit 110 may be configured to radiate light onto a column of cell panels 12, 14 selected as an inspection area in the second direction DR2 on the mother panel.

In an embodiment, the plurality of second supports 142 may be arranged parallel to each other in the first direction DR1, with adjustable spacing therebetween. In an embodiment, for example, the spacing between the plurality of second supports 142 may be adjusted to match the size of the cell panels 12, 14 on the mother panel. Accordingly, when the lighting unit 110 radiates light onto a column of cell panels 12, 14 in the second direction DR2, the imaging unit 120 may capture images aligned with the column of cell panels 12, 14 in the second direction DR2. In such an embodiment, since the plurality of second supports 142 is movable in the second direction DR2 while maintaining the spacing in the first direction DR1, it is possible for the imaging unit 120 to move in the second direction DR2 and capture images of each cell panel 12, 14 forming the column.

Therefore, in an embodiment, it is possible to effectively conduct a panel-by-panel defect inspection on a mother panel on which various sizes of cell panels 12, 14 may be formed for various types of the electronic device.

FIG. 8 is a diagram illustrating a lighting unit 110 in the inspection equipment 100 according to another embodiment of the disclosure. Referring to FIG. 8, in an embodiment, the lighting unit 110 may include a plurality of unit lights 112, and the plurality of unit lights 112 may be arranged linearly and installed separately on each of the first supports 132.

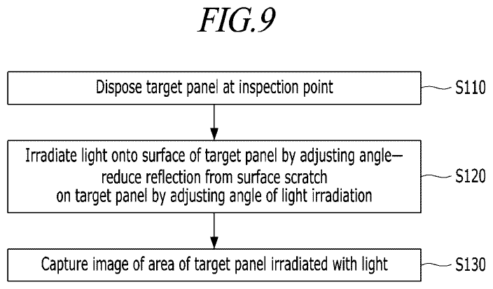

FIG. 9 is a flowchart illustrating an inspection method according to an embodiment of the disclosure. Referring to FIG. 9, the inspection method according to an embodiment of the disclosure includes a placement process S110, a light irradiation process S120, and an imaging process S130.

In the placement process S110, a target panel 10 is disposed at an inspection point. Referring to FIG. 2, the target panel 10 of an embodiment may be transferred in a first direction DR1. The target panel 10 may be transferred to be adjacent to a lighting unit 110 configured to radiate light onto a surface of the target panel 10.

In the light irradiation process S120, light is radiated onto the surface of the target panel 10 by adjusting an angle of irradiation. Referring to FIGS. 2 and 3, in an embodiment, light may be radiated onto the surface of the target panel 10 through the lighting unit 110 configured to adjust the angle of light irradiation relative to the target panel 10. In an embodiment, for example, an angle of a light source inside the lighting unit 110 may be adjusted, or an angle of a supporting member for the lighting unit 110 may be adjusted. In the light irradiation process S120, unidirectional diffused light may be radiated onto the target panel 10. Particularly, in an embodiment, by adjusting the angle of light irradiation, it is possible to reduce reflection from a surface scratch on the target panel 10.

Referring to FIGS. 4 and 5, when light is radiated onto the surface of the target panel 10, significant scattering occurs in the extrinsic defect caused by the surface foreign substance O, whereas less scattering occurs in the intrinsic defect caused by the surface scratch S. Particularly, by adjusting the irradiation angle of unidirectional diffused light, it is possible to reduce the scattering caused by the scratch S. When an irradiation angle of unidirectional diffused light is adjusted, the amount of light reflected from the intrinsic defect caused by the scratch S may be adjusted to be similar to the amount of light reflected from the normal surface of the target panel 10.

In an embodiment, light may be radiated onto a plurality of inspection areas of the target panel 10 using a plurality of lights arranged in parallel with each other in the first direction DR1. In an embodiment, for example, a plurality of first supports 132 may be provided, and each of the plurality of first support 132 may be equipped with the lighting unit 110. The first support 132 may have a bar structure extending in the second direction DR2, and the plurality of first supports 132 may be arranged parallel to each other in the first direction DR1. Accordingly, the lighting unit 110 may move in the first direction DR1 and selectively position itself to radiate light onto a single line L of cell panels 12 arranged in the second direction DR2.

In the imaging process S130, an image of an area of the target panel 10 irradiated with light is captured. Referring to FIGS. 2 and 3, when light is radiated onto the single line L of cell panels 12 arranged in the second direction DR2, a plurality of cameras 122 arranged in the second direction DR2 may capture images. In such an embodiment, the cameras 122 may move in the second direction DR2 to capture images of each cell panel 12 from the single line L of cell panels 12.

As described above, in an embodiment, by radiating diffused light and adjusting the angle of directional light irradiation, it is possible to reduce the scattering caused by scratch S. Therefore, by adjusting the angle of light radiated onto the target panel 10, intrinsic defects caused by surface scratches S may not appear in the image, but extrinsic defects caused by surface foreign substances O may selectively appear in the image. That is, in the image of the target panel 10, the image of surface scratches S may be indistinguishable from the surface image of a defect-free target panel 10. Therefore, according to an embodiment, it is possible to selectively inspect surface foreign substances O while excluding surface scratches S from the inspection on the target panel 10.

In such an embodiment, images may be obtained, respectively, from the plurality of inspection areas of the target panel 10 using the plurality of cameras 122. In an embodiment, for example, a plurality of second supports 142 may be provided, with the camera 122 installed on each of the plurality of second supports 142. The second support 142 may have a bar structure extending in the second direction DR2, and the plurality of second supports 142 may be arranged parallel to each other in the first direction DR1.

Accordingly, the plurality of cameras 122 may move in the second direction DR2, which intersects the first direction DR1, while maintaining spacing between the plurality of cameras 122 in the first direction DR1. The plurality of cameras 122 may capture an image of each cell panel 12 while moving in the second direction DR2. Accordingly, it is possible to obtain images and perform defect inspection simultaneously for multiple cell panels 12 that form a plurality of columns in the second direction DR2.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An inspection apparatus comprising:
a lighting unit which irradiates light onto a surface of a target panel by adjusting an angle;
an imaging unit which captures an image of an area of the target panel irradiated with the light by the lighting unit;
a first transferring unit which moves the lighting unit above the target panel; and
a second transferring unit which moves the imaging unit above the target panel.

2. The inspection apparatus of claim 1, wherein the lighting unit comprises a light source which emits unidirectional diffused light.

3. The inspection apparatus of claim 1, wherein the target panel is transferred in a first direction, and
wherein the first transferring unit comprises a first support movable in the first direction, wherein the lighting unit is disposed on the first support.

4. The inspection apparatus of claim 3, wherein the second transferring unit comprises a second support movable in the first direction and in a second direction intersecting the first direction, wherein the imaging unit is disposed on the second support.

5. The inspection apparatus of claim 4, wherein the first support is provided in plurality, and the lighting unit is disposed on each of a plurality of first supports, and
wherein the plurality of first supports is arranged in parallel with each other in the first direction with adjustable spacing therebetween.

6. The inspection apparatus of claim 5, wherein the second support is provided in plurality, and the imaging unit is disposed on each of a plurality of second supports, and
wherein the plurality of second supports is arranged in parallel with each other in the first direction with adjustable spacing therebetween.

7. The inspection apparatus of claim 6, wherein the plurality of second supports are movable in the second direction while maintaining the spacing in the first direction.

8. The inspection apparatus of claim 4, wherein the imaging unit comprises a plurality of cameras disposed along the second support extending in the second direction.

9. The inspection apparatus of claim 1, wherein the lighting unit adjusts an angle of a light source inside the lighting unit.

10. The inspection apparatus of claim 1, wherein an angle of a supporting member, which supports the lighting unit, is adjusted.

11. The inspection apparatus of claim 4, wherein the lighting unit comprises a plurality of unit lights linearly arranged on the first support extending in the second direction.

12. An inspection method comprising:
disposing a target panel at an inspection point;
radiating light onto a surface of the target panel by adjusting an angle of light irradiation; and
capturing an image of an area of the target panel irradiated with the light,
wherein, in the radiating the light, the angle of light irradiation is adjusted in a way such that reflection from a surface scratch on the target panel is reduced.

13. The inspection method of claim 12, wherein, in the radiating the light, unidirectional diffused light is radiated onto the target panel.

14. The inspection method of claim 12, wherein, in the disposing the target panel, the target panel is transferred in a first direction, and
wherein, in the radiating the light, the light is radiated onto a plurality of inspection areas of the target panel using a plurality of lights arranged in parallel with each other in the first direction.

15. The inspection method of claim 14, wherein the capturing the image comprises obtaining images, respectively, from the plurality of inspection areas of the target panel using a plurality of cameras.

16. The inspection method of claim 15, wherein the capturing the image comprises moving the plurality of cameras in a second direction intersecting the first direction while maintaining spacing between the plurality of cameras in the first direction.

17. The inspection method of claim 12, wherein, in the radiating the light, the angle of light irradiation is adjusted to allow an image of the surface scratch to be indistinguishable from a surface image of the target panel in a captured image of the target panel.

18. The inspection method of claim 17, wherein, in the captured image of the target panel, an image of a surface foreign substance on the target panel is distinguishable from the surface image of the target panel.

19. The inspection method of claim 12, wherein, in the radiating the light, the angle of light irradiation is adjusted by adjusting an angle of a light source inside a lighting unit.

20. The inspection method of claim 12, wherein, in the radiating the light, the angle of light irradiation is adjusted by adjusting an angle of a support member which supports a lighting unit.
